(19) United States
(12) Patent Application Publication
(10) Pub. No.: US 2018/0073979 A1
(43) Pub. Date: Mar. 15, 2018

(54) DEFECT INSPECTION SYSTEM, METHOD OF INSPECTING DEFECTS, AND METHOD OF FABRICATING SEMICONDUCTOR DEVICE USING THE METHOD

(71) Applicant: SAMSUNG ELECTRONICS CO., LTD., Suwon-si (KR)

(72) Inventors: Seongkeun CHO, Suwon-si (KR); Sang-woo BAE, Seoul (KR); Won-don JOO, Incheon (KR); Sang-don JANG, Suwon-si (KR)

(21) Appl. No.: 15/459,393

(22) Filed: Mar. 15, 2017

(30) Foreign Application Priority Data
Sep. 9, 2016 (KR) 10-2016-0116576

(51) Int. Cl. G01N 21/21; G01N 21/95; G01N 21/88; H04N 5/225; H04N 5/247

(52) U.S. Cl. CPC G01N 21/211; G01N 21/9501; G01N 21/8806; G01N 2021/8848; H04N 5/247; G01N 2201/0683; H04N 5/2256

(57) ABSTRACT

Provided are a defect inspection system and a method of inspecting a defect, by which a defect in an inspection target may be precisely detected at a high speed. The defect inspection system includes a light source, a linear polarizer to linearly polarize light from the light source, a compensator to circularly or elliptically polarize light from the linear polarizer, a stage on which an inspection target is located, a polarization analyzer to selectively transmit light reflected by the inspection target, and a first camera to collect light from the polarization analyzer. Light transmitted through the compensator is obliquely incident to the inspection target, and reference light, which corresponds to light reflected in a defectless state, from among the light reflected by the inspection target, is blocked by the polarization analyzer.

### CROSS-REFERENCE TO RELATED APPLICATION

Korean Patent Application No. 10-2016-0116576, filed on Sep. 9, 2016, in the Korean Intellectual Property Office, and entitled: “Defect Inspection System, Method of Inspecting Defects, and Method of Fabricating Semiconductor Device Using the Method,” is incorporated by reference herein in its entirety.

### BACKGROUND

### 1. Field

Embodiments relate to a defect inspection system and a method of inspecting defects, and more particularly, to a defect inspection system and a method of inspecting defects based on ellipsometry.

### 2. Description of the Related Art

In general, ellipsometry is an optical technique for studying dielectric characteristics of a wafer. Ellipsometry may include analyzing a variation in the polarization of reflection light reflected by a sample (e.g., a surface of a wafer) and calculating information regarding the sample. For example, when light is reflected by the sample, a polarization state of reflection light may vary according to optical properties of materials included in the sample and a layer thickness of the sample. In ellipsometry, the variation in polarization of reflection light may be measured so that a complex refractive index or dielectric function tensor, which is a basic physical quantity of a material, may be obtained, and information (e.g., a type of a material, a crystalline state, a chemical structure, and electrical conductivity) regarding the sample may be derived.

Typical spectroscopic ellipsometry (SE) or spectroscopic imaging ellipsometry (SIE) use a broadband light source. According to SE or SIE, a sample may be repetitively measured by using light having various wavelength ranges e.g., about 250 nm to about 1700 nm, to obtain ellipsometry parameters Ψ and Δ of the sample. Extracted data of the ellipsometry parameters Ψ and Δ may be applied again to complicated regression analysis modeling to obtain a critical dimension (CD) of the sample and determine whether there is a defect in the sample.

### SUMMARY

One or more embodiments is directed to a defect inspection system including a light source, a linear polarizer to polarize light from the light source, a compensator to circularly or elliptically polarize light from the linear polarizer, a stage on which an inspection target is located, a polarization analyzer to selectively transmit light reflected by the inspection target, and a first camera to collect light from the polarization analyzer. Light transmitted through the compensator is obliquely incident to the inspection target, and reference light, which corresponds to light reflected in a defectless state, from among the light reflected by the inspection target, is blocked by the polarization analyzer, and a defect of the inspection target is inspected.

One or more embodiments is directed to a multi-head defect inspection system including at least two inspection heads and a stage on which an inspection target is located. Each of the inspection heads includes a light source, a linear polarizer to linearly polarize light from the light source, a compensator to circularly or elliptically polarize light from the linear polarizer, a polarization analyzer to selectively transmit light reflected by the inspection target, and at least one camera to collect light from the polarization analyzer. Light transmitted through the compensator is obliquely incident to the inspection target, reference light, which corresponds to light reflected in a defectless state, from among the light reflected by the inspection target, is blocked by the polarization analyzer.

One or more embodiments is directed to a method of inspecting defects. The method includes setting null conditions of a defect inspection system by using a defectless sample, checking an inspection target by using the defect inspection system under the null conditions, and analyzing a checking result of the inspection target and determining whether there is a defect in the inspection target. The defect inspection system circularly or elliptically polarizes light, allows the circularly or elliptically polarized light to be obliquely incident to the inspection target, detects reflected light, and inspects a defect in the inspection target. The null conditions are conditions for blocking light reflected by the sample. The determination of whether there is a defect in the inspection target may include comparing the checking result of the inspection target with a checking result of the sample under the null conditions.

One or more embodiments is directed to a method of fabricating a semiconductor device. The method includes setting null conditions of a defect inspection system by using a defectless sample, checking a wafer by using the defect inspection system that is under the null conditions, analyzing a checking result of the wafer and determining whether there is a defect in the wafer, and performing a semiconductor process on the wafer when there is no defect in the wafer. The defect inspection system circularly or elliptically polarizes light, allows the circularly or elliptically polarized light to be obliquely incident to the wafer, detects reflected light, and inspects a defect in the wafer. The null conditions are conditions under which light reflected by the sample is completely blocked. The determination of whether there is a defect in the wafer may include comparing the checking result of the wafer with a checking result of the sample that is in the null conditions.

One or more embodiments is directed to a defect inspection system that includes a light source, a linear polarizer to linearly polarize light from the light source, a stage on which an inspection target is to be located and positioned to receive light at an oblique angle, a polarization analyzer to selectively transmit light reflected by the inspection target, and a camera to collect light from the polarization analyzer, wherein a minority of light incident on the polarization analyzer from a defectless target is incident on the camera.

### BRIEF DESCRIPTION OF THE DRAWINGS

Features will become apparent to those of skill in the art by describing in detail exemplary embodiments with reference to the attached drawings in which:

FIG. 1 illustrates a schematic diagram of a defect inspection system according to an embodiment;

FIGS. 2A and 2B illustrate schematic diagrams of principles by which defects are detected by simplifying the defect inspection system of FIG. 1;

FIG. 3 illustrates a schematic diagram of principles by which null conditions are obtained by simplifying the defect inspection system of FIG. 1;

FIG. 4A illustrates a cross-sectional view of a sample used to obtain null conditions;

FIG. 4B illustrates simulation images relative to intensity of light;

FIG. 5A illustrates a cross-sectional view of a defective wafer;

FIGS. 5B to 5D illustrate simulation images relative to light intensity when null conditions are not applied to a wafer and images of normalized intensity errors;

FIG. 6A illustrates a cross-sectional view of a defective wafer;

FIGS. 6B to 6D illustrate simulation images relative to light intensity when null conditions are applied to a wafer and images of normalized intensity errors;

FIG. 7 illustrates a graph of a normalized intensity error of FIG. 6D relative to a rotation angle A of a polarization analyzer;

FIG. 8A illustrates a cross-sectional view of a defectless wafer on which patterns are formed in a two-dimensional (2D) array;

FIGS. 8B and 8C illustrate a cross-sectional view and a plan view of a defective wafer on which patterns are formed in a 2D array;

FIG. 8D illustrates a graph of a normalized intensity error relative to a rotation angle of a polarization analyzer;

FIG. 9A illustrates a cross-sectional view of a defectless wafer on which line & space (L/S) patterns are formed;

FIGS. 9B and 9C illustrate a cross-sectional view and a plan view of a defective wafer on which L/S patterns are formed;

FIG. 9D illustrates a graph showing a normalized intensity error relative to a rotation angle of a polarization analyzer;

FIGS. 10 to 14 illustrate schematic diagrams showing defect inspection systems according to embodiments;

FIG. 15 illustrates a plan view of a mask that may be located vertically over an inspection target or in front of a camera in defect inspection systems according to embodiments;

FIG. 16 illustrates a schematic diagram of a multi-head defect inspection system according to an embodiment;

FIG. 17 illustrates a flowchart of a method of inspecting defects, according to an embodiment; and

FIG. 18 illustrates a flowchart of a method of fabricating a semiconductor device by using a method of inspecting defects, according to an embodiment.

### DETAILED DESCRIPTION

Various embodiments will now be described more fully with reference to the accompanying drawings in which some embodiments are shown. Like reference numerals in the drawings denote like elements, and thus descriptions thereof will be omitted.

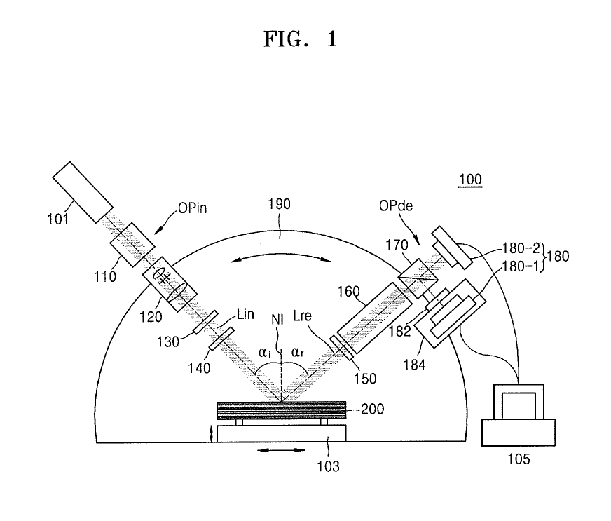

FIG. 1 is a schematic diagram showing a configuration of a defect inspection system 100 according to an embodiment. Referring to FIG. 1, the defect inspection system 100 according to the present embodiment may include a light source 101, a stage 103, a monochromator 110, a beam collimator 120, a linear polarizer 130, a compensator 140, a polarization analyzer 150, a low-magnification optics 160, a beam splitter 170, a camera unit 180, a linear stage 190, and an analysis computer 105.

The light source 101 may be a broadband light source or a multi-wavelength light source that generates light having a wide wavelength range, e.g., about 250 nm to about 1700 nm. Also, the light source 101 may be a wavelength-tunable light source. In addition, the light source 101 is not limited to a broadband light source. For example, the light source 101 may be a single-wavelength laser light source to generate light having a single wavelength, e.g., monochromatic light. When the light source 101 is a single-wavelength laser light source, the defect inspection system 100 may include a plurality of laser light sources to generate light having different wavelengths, and a change of a light source may be made according to a required wavelength.

The stage 103 may be a device on which an inspection target 200 is located, and move in an x direction, a y direction, and a z direction. Thus, the stage 103 may be referred to as an xyz stage. The stage 103 may be moved by a motor. By moving the inspection target 200 via the stage 103, an inspection may be performed on a required position of the inspection target 200. The inspection target 200 may be one of various devices serving as inspection targets, e.g., a wafer, a semiconductor package, a semiconductor chip, a display panel, and so forth. For example, the inspection target 200 may be a wafer. Here, the wafer may be a wafer having a top surface on which periodic patterns are formed or a patternless bare wafer. Meanwhile, a sample may be located on the stage 103. The sample may be a defectless wafer and used to obtain null conditions of the defect inspection system 100. The null conditions will be described below in further detail with reference to FIG. 3.

The monochromator 110 may convert light having a broadband wavelength from the light source 101 into single-wavelength light and output the single-wavelength light. When a single-wavelength laser light source is used as the light source 101, the monochromator 110 may be omitted.

The beam collimator 120 may collimate single-wavelength light from the monochromator 110 and output collimated light. Meanwhile, when the single-wavelength laser light source is used as the light source 101, light from the light source 101 may be directly incident to the beam collimator 120. Also, since the single-wavelength laser light source has a narrow linewidth and coherence, dispersion of light may be reduced, and the beam collimator 120 may be omitted.

The linear polarizer 130 may linearly polarize light from the beam collimator 120 and output linearly polarized light. For example, the linear polarizer 130 may transmit only a p polarizing element (or a horizontal element) or an s polarizing element (or a vertical element) from among incident light and output the p polarizing element or the s polarizing element to linearly polarize the incident light.

The compensator 140 may circularly polarize or elliptically polarize light from the linear polarizer 130 and output circularly polarized light or elliptically polarized light. The compensator 140 may apply a phase difference to light incident thereon to convert linearly polarized light into circularly polarized light or elliptically polarized light or to convert circularly polarized light into linearly polarized light. Thus, the compensator 140 may be referred to as a phase retarder. For example, the compensator 140 may be a quarter-wave plate.

The polarization analyzer 150 may selectively transmit reflection light, which is reflected by the inspection target 200 and polarized in a changed direction, e.g., light changes phase by 180 degrees when reflected. For example, the polarization analyzer 150 may be a kind of linear polarizer configured to transmit only a specific polarizing element, from among incident light, and block the remaining elements. In some cases, the polarization analyzer 150 may be located at a rear end of the low-magnification optics 160, e.g., between the low magnification optics 160 and the beam splitter 170.

For reference, a system (e.g., the defect inspection system 100 according to the present embodiment) including the linear polarizer 130, the compensator 140, and the polarization analyzer 150 is referred to as a PCSA ellipsometer system. Here, P may denote a linear polarizer, C may denote a compensator, S may denote a sample, and A may denote a polarization analyzer. Meanwhile, the defect inspection system 100 according to the present embodiment is not limited to the PCSA ellipsometer system and may be embodied by a PSA ellipsometer system, e.g., without the compensator, a PSCA ellipsometer system, or a PCSCA ellipsometer system, e.g., with another compensator between the sample and the analyzer. Furthermore, the defect inspection system 100 according to the present embodiment may include a phase modulator instead of the compensator 140. When the defect inspection system 100 uses a phase modulator, precise inspection results may be stably obtained by removing mechanical jitters.

The low-magnification optics 160, which is a kind of imaging optics, may image light from the polarization analyzer 150 at an equal magnification ratio or a low magnification ratio. Here, the low magnification ratio may range from an equal magnification ratio of 1:1 to a magnification ratio of 1:100. Meanwhile, a magnification ratio of more than 1:100 may be classified as a high magnification ratio. By using the low-magnification optics 160, the defect inspection system 100 according to the present embodiment may have a far wider field of view (FOV) than typical spectroscopic ellipsometry (SE) or spectroscopic imaging ellipsometry (SIE) and perform a defect inspection at a high speed. For example, assuming that a 1:100 low-magnification optics 160 has an FOV corresponding to an area A/100, at least 100 shots may be needed to inspect a defect in an inspection target 200 having an area A. In contrast, since a 1:10 low-magnification optics 160 has an FOV corresponding to an area A, it may be inspected whether there is a defect in the inspection target 200 having the area A with only one shot.

The low-magnification optics 160 may calibrate distortion of an image, which may occur due to the inclination of the surface of the inspection target 200 with respect to reflected light, and image the surface of the inspection target 200 parallel to the camera unit 180. For example, the low-magnification optics 160 may be embodied by Scheimpflug optics. The low-magnification optics 160 may include at least one reflecting mirror to change a path of light and/prevent distortion. The low-magnification optics 160 may be embodied by a zoom lens system capable of freely controlling a magnification within the range of 1:1 to 1:M (1<M≦100).

The beam splitter 170 may split light from the low-magnification optics 160 into two light beams and output the two light beams. The beam splitter 170 may be a non-polarizing beam splitter or a polarizing beam splitter. A non-polarizing beam splitter may split light irrespective of polarization, while a polarizing beam splitter may split light according to polarization. In the defect inspection system 100 according to the present embodiment, the beam splitter 170 may be a non-polarizing beam splitter. Also, the beam splitter 170 may split incident light at an intensity ratio of 1:1 or an intensity ratio of 1:N (N>1).

The camera unit 180 may include a first camera 180-1 and a second camera 180-2. As shown in FIG. 1, each of the first camera 180-1 and the second camera 180-2 may be located in such a position as to collect light beams split by the beam splitter 170. The first camera 180-1 may be located at a side surface of the beam splitter 170, and the second camera 180-2 may be located at a rear end of the beam splitter 170, but positions of the first camera 180-1 and the second camera 180-2 may be exchanged. Each of the first camera 180-1 and the second camera 180-2 may be, e.g., a charge-coupled device (CCD) camera or a complementary metal-oxide-semiconductor (CMOS) camera.

The first camera 180-1 may be a high-sensitivity camera capable of checking even a very feeble signal, e.g., dim, faint, low intensity signals. For example, the first camera 180-1 may have an international organization for standardization (ISO) sensitivity of about 3000 or more. The first camera 180-1 may be, e.g., an electron multiplying CCD (EMCCD) camera or a scientific CMOS (sCMOS) camera. Very feeble scattered light generated by defects may be detected under null conditions by using the high-sensitivity first camera 180-1.

The first camera 180-1 may be located in an airtight box 184 to completely block light from the outside, while a shutter 182 may be located at a front end of an entrance of the first camera 180-1. The shutter 182 and the box 184 may protect pixels of the first camera 180-1 that are sensitive to low luminance. For example, the shutter 182 may be closed when null conditions are not applied, while the shutter 182 may be opened when the null conditions are applied, so that the shutter 182 may protect the pixels from reflection light beams having high intensities. For example, the shutter 182 may be opened at only a luminance of about 0.05 Lx or less, but conditions for opening the shutter 182 are not limited thereto.

The second camera 180-2 may be an ordinary camera or low-sensitivity camera having a lower sensitivity than the first camera 180-1. The second camera 180-2 may be used to obtain null conditions of the defect inspection system 100. Alternatively, the first camera 180-1 may be used together with the second camera 180-2 to obtain the null conditions more precisely. For example, in a measurement process for obtaining the null conditions, reflection light may be measured by using the second camera 180-2 in the range of reflection light beams having high intensities, while reflection light may be measured by using the first camera 180-1 having high sensitivity in the range of reflection light beams that are near to the null conditions and have low intensities.

The second camera 180-2 used to obtain the null conditions may be an area camera. In contrast, the first camera 180-1 may be a line scan camera to inspect the inspection target 200 at a high speed. In addition, the first camera 180-1 may be an area step camera or an area scan camera.

The linear stage 190 may support an incidence optics OPin to allow light to be incident to the inspection target 200 and a detection optics OPde to collect light reflected by the inspection target 200. Here, the incidence optics OPin may include optical devices from the light source 101 to the inspection target 200 and the detection optics OPde may include optical devices from the inspection target 200 to the camera unit 180. Also, the linear stage 190 may rotate the incident optics OPin and the detection optics OPde so that incident light Lin and reflection light Lre move at the same angle to a normal line Nl to a top surface of the inspection target 200. For example, as indicated by a bidirectional curved arrow, the linear stage 190 may rotate the incident optics OPin according to characteristics of the inspection target 200 or a sample and control an incidence angle αᵢ so that the detection optics OPde may be located at a reflection angle αᵣ, which is equal to the incidence angle αᵢ.

The analysis computer 105 may receive information output by the first camera 180-1 and the second camera 180-2 and analyze the information. For example, the analysis computer 105 may be a personal computer (PC), a workstation, a supercomputer, and so forth which may include an analysis process. The analysis computer 105 may obtain null conditions of the defect inspection system 100 by analyzing the detected light, and determine whether there are defects in the inspection target 200. The analysis computer 105 may generally control the defect inspection system 100.

In the defect inspection system 100 according to the present embodiment, rotation angles (i.e., azimuths) of the linear polarizer 130, the compensator 140, and the polarization analyzer 150 about an optical axis may be controlled so that null conditions under which reference light is blocked by the polarization analyzer 150 may be set. Hereinafter, reference light will refer to light reflected by a defectless standard sample, e.g., a defectless normal wafer

To control the rotation angles about the optical axis, the linear polarizer 130, the compensator 140, and the polarization analyzer 150 may be installed on a motor-driven rotation support and rotate about the optical axis. The rotation of the linear polarizer 130, the compensator 140, and the polarization analyzer 150 may be continuous rotation or discontinuous rotation, e.g., at only predetermined angles. In the defect inspection system 100 according to the present embodiment, the rotation of the linear polarizer 130, the compensator 140, and the polarization analyzer 150 may be discontinuous rotation.

The linear polarizer 130 and the polarization analyzer 150 may be embodied by a wire grid static linear polarizer or a Glan Thompson static linear polarizer. However, embodiments are not limited thereto, and the linear polarizer 130 and the polarization analyzer 150 may be embodied by an electronic device, e.g., a Faraday rotator, capable of changing a direction of polarized light in response to an electric signal. Also, the compensator 140 may be replaced by an electronic device, e.g., a piezoelectric phase modulator, controlled with respect to an electric signal. When the linear polarizer 130, the compensator 140, and the polarization analyzer 150 are embodied by electronic devices, the above-described motor-driven rotation support may be omitted.

By using the low-magnification optics 160, the defect inspection system 100 according to the present embodiment may have a far wider FOV than a typical SE or SIE and perform a defect inspection at a high speed. Also, null conditions may be obtained and the inspection target 200 may be checked by using the first camera 180-1 so that a defect in the inspection target 200 may be precisely detected. Thus, the defect inspection system 100 according to the present embodiment may contribute toward fabricating a reliable semiconductor device and increasing yield of a semiconductor process.

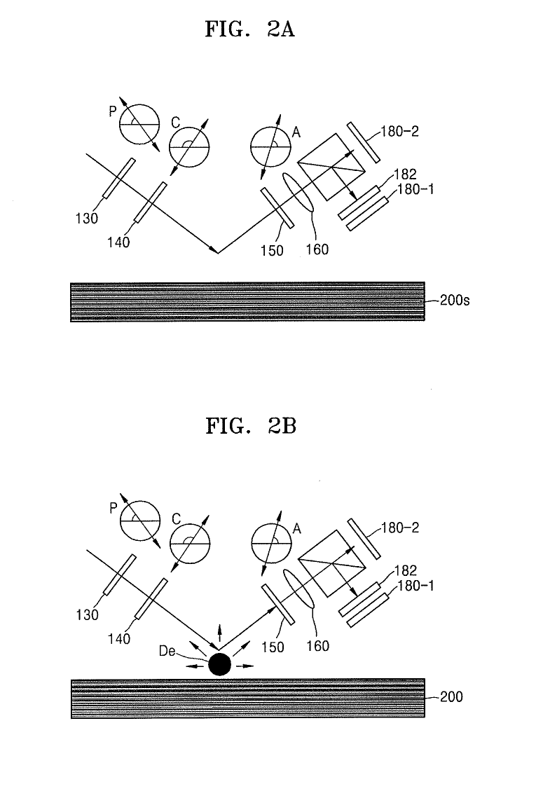

FIGS. 2A and 2B are conceptual diagrams illustrating the principle by which defects are detected by simplifying the defect inspection system 100 of FIG. 1.

Referring to FIG. 2A, to begin with, null conditions may be obtained in the defect inspection system 100. Specifically, the linear polarizer 130, the compensator 140, and the polarization analyser 150 may be rotated at a specific angle to a defectless sample 200s, e.g., a defectless wafer, based on an ellipsometry theory so that an intensity of light collected by the camera unit 180, e.g., the second camera 180-2, may be measured. Rotation angles (i.e., azimuths) of the linear polarizer 130, the compensator 140, and the polarization analyzer 150 about an optical axis may be denoted by P, C, and A, respectively. The intensity of light collected by the camera unit 180 may be measured three or four times by changing the rotation angles of the linear polarizer 130, the compensator 140, and the polarization analyzer 150 to obtain ellipsometric parameters Ψ and Δ of the sample 200s. Thus, null conditions for blocking reference light incident to the camera unit 180 may be obtained.

Here, Ψ may be a parameter related to p polarization and s polarization, e.g., the amplitudes thereof, and Δ may be a parameter related to phase retardation. The null conditions may refer to specific rotation angles of the linear polarizer 130, the compensator 140, and the polarization analyzer 150 to block reference light. Under null conditions, reference light may be completely blocked by the polarization analyzer 150 so that reference light incident on the camera unit 180 may completely disappear. In another case, under the null conditions, reference light may not be completely blocked by the polarization analyzer 150 so that minimum reference light may be incident to the camera unit 180. In other words, a minority of light incident, e.g., 25% or less, 10% or less, down to and including zero, on the polarization analyzer 150 from a defectless target is transmitted thereby to the camera unit 180.

Next, the inspection target 200 may be inspected using the defect inspection system 100 that is under the null conditions to determine whether there is a defect De present. If there is no defect De in the inspection target 200, reference light may be totally or mostly blocked by the polarization analyzer 150 so that the same intensity as in the sample 200s may be measured. Otherwise, if there is a defect De in the inspection target 200, scattered light beams caused by the defect De may be transmitted through the polarization analyzer 150 and incident to the camera unit 180. Although the scattered light beams caused by the defect De have very low intensities, the scattered light beams may be properly detected by the first camera 180-1 having high sensitivity. Here, the defect De may be a nano-defect having a diameter or width of about 100 nm or less, but the size of the defect De is not limited thereto.

Briefly, null conditions of the defect inspection system 100 may be obtained by using the defectless sample 200s, and the inspection target 200 may be checked by using the defect inspection system 100 that is under the null conditions. If the same intensity as in the sample 200s is obtained as a checking result, it may be determined that there is no defect in the inspection target 200. Otherwise, if a different intensity than in the sample 200s is obtained as the checking result, it may be determined that there is a defect in the inspection target 200.

FIG. 3 is a schematic diagram illustrating principles by which null conditions are obtained by simplifying the defect inspection system 100 of FIG. 1.

Referring to FIG. 3, light may be irradiated to a defectless sample 200s by using the defect inspection system 100 of FIG. 1, and light (i.e., reference light) reflected by the sample 200s may be detected. Assuming that angles at which the linear polarizer 130, the compensator 140, and the polarization analyzer 150 rotate about an optical axis are referred to as P, C, and A, respectively, E(P,C,A), which is a complex amplitude of light transmitted through the polarization analyzer 150, may be given by Equation (1). Here, a quarter-wave plate may be used as the compensator 140.

E(P,C,A)=rₚ cos A[cos(P−C)cos C+i sin C sin(C−P)]+rₛ sin A[cos(P−C)sin C−i cos C sin(C−P)] Equation (1),

wherein rₚ denotes a reflection coefficient of the sample 200s with respect to p polarized light, rₛ denotes a reflection coefficient of the sample 200s with respect to s polarized light, and rₚ and rₛ may have a relationship of Equation (2) to ellipsometric parameters Ψ and Δ.

tan(Ψ)e^{iΔ}≡rₚ/rₛ Equation (2)

Assuming that I(P,C,A) is intensity of light detected in the camera unit 180 (e.g., the second camera 180-2), at least three values of I(P,C,A) may be measured and obtained by applying different values to P, C, and A at least three times. Meanwhile, I(P,C,A) and E(P,C,A) may have a relationship of Equation (3) to E(P,C,A).

I(P,C,A)=|E(P,C,A)|² Equation (3)

For example, when the at least three values of I(P,C,A) are I₁(0,π/4,0), I₂(0,π/4,π/4), and I₃(π/4, π/4, π/2), tan Ψ and sin Δ may be expressed by Equations (4) and (5):

tan Ψ=(I₁/I₃)^{1/2} Equation (4)

sin Δ=(I₁+I₃−2I₂)/2(I₁*I₃)^{1/2} Equation (5)

The ellipsometric parameters Ψ and Δ may be obtained by Equations (4) and (5). In addition, the ellipsometric parameters I′ and A may be obtained by measuring I(P,C,A) at least three times by applying different combinations of values P, C, and A than described above. Meanwhile, although at least three combinations of values P, C, and A are needed to obtain the elliptical polarization parameters Ψ and Δ, I(P,C,A) may be measured at least four times by using at least four combinations of values P, C, and A to obtain precise elliptical polarization parameters Ψ and Δ.

After obtaining the ellipsometric parameters Ψ and Δ, null conditions, namely, conditions for preventing reference light from passing through the polarization analyzer 150, may be obtained as follows.

By setting a rotation angle C as π/4, Equation (1) may be expressed as shown in Equation (1-1):

E(P,C,A)=rₛ/2^{1/2} cos Ae^{-i(π/4-p)}[rₚ/rₛ*e^{i(π/2-2P)}+tan A] Equation (1-1).

From the null conditions (i.e., conditions under which E(P,π/4,A) is equal to 0 ((E(P,π/4,A)=0)) and Equation (2), values A and P may be obtained (A=Ψ, and P=Δ/2−π/4). Since the elliptical polarization parameters Ψ and Δ are already obtained, the values A and P may be calculated. Finally, from the null conditions, the values C, A, and P may be obtained (C=π/4, AΨ, and P=Δ/2-π/4). In addition, the rotation angle C may be set as a value other than π/4.

To sum up, in the defectless sample 200s, the elliptical polarization parameters Ψ and Δ may be obtained by measuring I(0,π/4,0), I(0,π/4,π/4), and 4π/4,π/4,π/2) three times (or by measuring I(P,C,A) with different combinations of values P, C, and A). Thus, the values P, C, and A corresponding to the null conditions may be obtained based on the elliptical polarization parameters Ψ and Δ. Thereafter, feeble light scattered at a nano-defect may be detected via the first camera 180-1 by using the defect inspection system 100 that is under null conditions, so that it may be determined whether there is a defect in the inspection target 200. The above-described method of inspecting a defect may be used not only for a patternless bare wafer but also for a wafer on which a periodic pattern is formed.

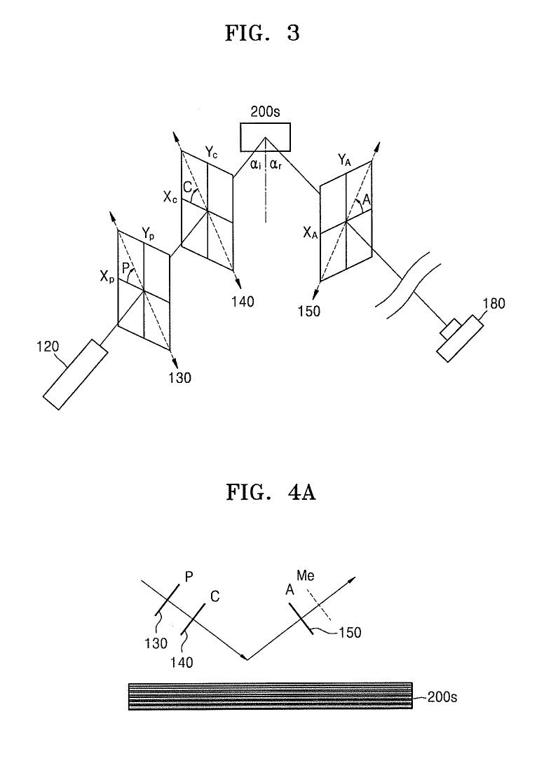

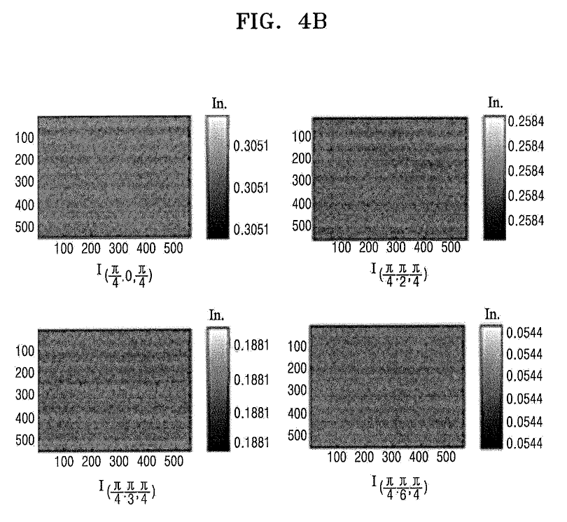

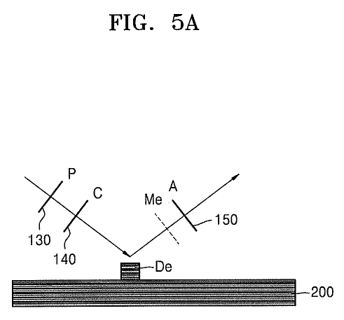

FIG. 4A is a cross-sectional view of a sample used to obtain null conditions, and FIG. 4B shows simulation images relative to intensity I(P,C,A) of light. In FIG. 4B, intensity (In.) may refer to reflected intensity relative to incident light.

Referring to FIGS. 4A and 4B, intensity I(P,C,A) of light reflected by a sample 200s having a thickness of about 300 nm may be obtained by using a finite-difference time-domain (FDTD) simulation, which may simulate the defect inspection system 100 of FIG. 1. The FDTD simulation will now be briefly described. Assuming that a surface of the sample 200s is imaged on a detector (e.g., the second camera 180-2) through the low-magnification optics 160 at a magnification ratio of 1:1, a simulated region may be about 5 μm in width and length and about 1.4 μm in height, a light source may be located a distance of about 0.55 μm over the surface of the sample 200s, and 633-nm plane waves may be set to be incident at an angle of about 65° to a normal line to the surface of the sample 200s. Also, the second camera 180-2 may be a two-dimensional (2D) area camera, which may be about 5 μm in width and length, and located a distance of about 0.6 μm over the surface of the sample 200s. The second camera 180-2 may be simulated to detect elements Ex, Ey, and Ez of light reflected by the sample 200s, rotate and convert the elements Ex, Ey, and Ez of the light, and detect only light intensity of a final image in consideration of only elements transmitted through the polarization analyzer 150. For reference, in FIG. 4A, a dashed line Me behind the polarization analyzer 150 may indicate that the intensity of light transmitted through the polarization analyzer 150 is obtained.

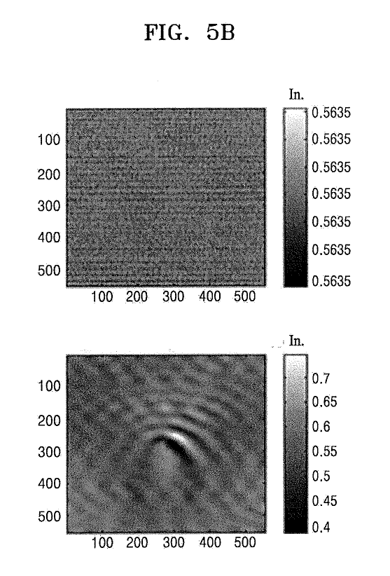

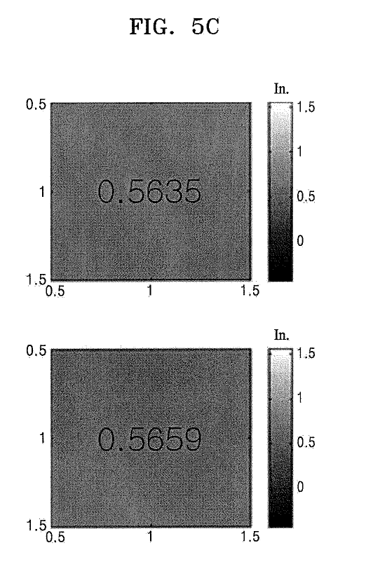

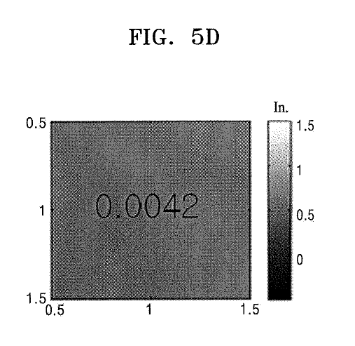

FIG. 4B shows simulation images of intensity I(P,C,A) of light while varying values P, C, and A to obtain null conditions. Ellipsometric parameters Ψ and Δ may be obtained by measuring I(0,π/4,0), I(0,π/4,π/4), and I(n/4,π/4,π/2) three times as shown in Equations (4) and (5). However, the ellipsometric parameters Ψ and Δ may be obtained by measuring light intensity with different combinations of values P, C, and A. For example, the simulation images of FIG. 4B may be obtained by measuring I(π/4,0,π/4), I(π/4,π/2,π/4), I(π/4,π/3,π/4), and I(π/4,π/6,π/4) with four combinations of values P, C, and A. Meanwhile, in FIG. 4B, figures on the abscissa and the ordinate simply denote 2D coordinate values as described below in further detail with reference to FIGS. 5B and 5C.

Equation (Ψ, Δ)=(0.4205, 0.1588) may be obtained by using Equations (1) and (2). It can be ascertained that this result is almost the same as Equation (Ψ, Δ)=(0.4347, 0.1573), which is obtained by solving an air-silicon-air three-phase system based on Fresnel equations. After the ellipsometric parameters Ψ and Δ are obtained, π/4 may be applied to a rotation angle C and thus, Equation (P, C, A)=(−40.49°, 45°, 24.91°) may be obtained as null conditions.

FIG. 5A is a cross-sectional view of a defective wafer 200, and FIGS. 5B to 5D are simulation images relative to light intensity when null conditions are not applied to a wafer and images of normalized intensity errors.

Referring to FIGS. 5A to 5D, a defect De on the wafer 200 may have, e.g., silicon (Si) cube shape that is about 100 nm in width, length, and height. A dashed line Me in front of a polarization analyzer 150 of FIG. 5A may indicate that light intensity is obtained without the polarization analyzer 150 or without the application of null conditions.

Upper parts of FIGS. 5B and 5C show simulation images of light intensity of a defectless wafer, and lower parts of FIGS. 5B and 5C are simulation images of light intensity of the defective wafer 200. Here, the defectless wafer may correspond to, for example, the sample 200s of FIG. 4A. Meanwhile, each of the simulation images may correspond to one pixel size of the second camera 180-2, and each of an x-axis and a y-axis may be about 5 μm in length.

In each of the simulation images of FIG. 5B, light intensities are denoted by points of a 533×533 matrix. However, an actual light intensity may be detected as a resolution of one pixel of the second camera 180-2. By taking the average of light intensities denoted by the points of the matrix of FIG. 5B, the simulation images shown in FIG. 5C may be obtained. Thus, the simulation images of FIG. 5C may substantially correspond to one pixel of the second camera 180-2. Also, each of the simulation images of FIG. 5C is wholly denoted by the average intensity centering around coordinates (1, 1) on an x-y coordinate plane, and the average intensity of light is indicated in the center of the x-y coordinate plane.

The simulation image of FIG. 5D shows a difference in light intensity between a case in which there is no defect on the wafer 200 and a case in which there is a defect on the wafer 200, when null conditions are not applied. Specifically, the difference value shown in FIG. 5D may correspond to a value that is obtained by subtracting the average light intensity of an upper simulation image of FIG. 5C from the average light intensity of a lower simulation image of FIG. 5C and dividing the subtraction result by the average light intensity of the upper simulation image of FIG. 5C. Hereinafter, the difference value shown in FIG. 5D will be referred to as a “normalized intensity error.” When the null conditions are not applied, the normalized intensity error may be no more than about 0.0042 or 0.4%. Accordingly, it may be almost impossible to determine whether there is a defect on the wafer 200.

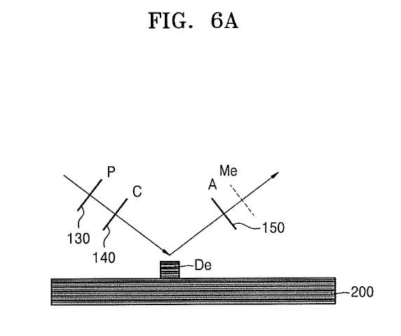

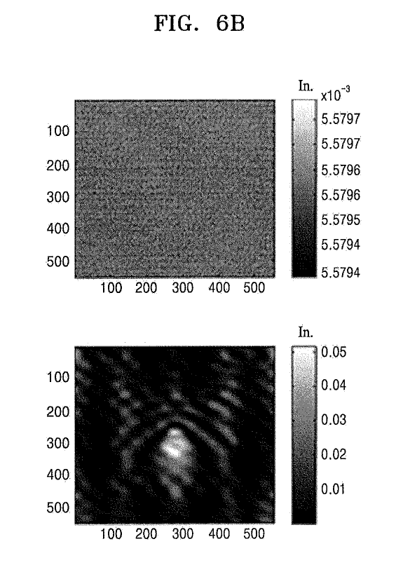

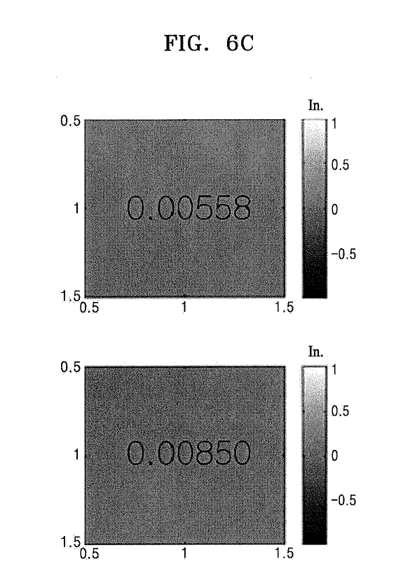

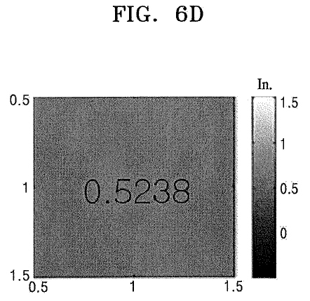

FIG. 6A is a cross-sectional view of a defective wafer 200, and FIGS. 6B to 6D are simulation images relative to light intensity when null conditions are applied to a wafer and images of normalized intensity errors.

Referring to FIGS. 6A to 6D, a defect De on the wafer 200 may also have a silicon cube shape that is about 100 nm in width, length, and height. A dashed line Me behind a polarization analyzer 150 of FIG. 6A may indicate that light intensity is obtained through the polarization analyzer 150 or with the application of null conditions.

FIGS. 6B and 6C are the same as described with reference to FIGS. 5B and 5C except that the null conditions are applied. It can be seen that when the null conditions are applied, detected light intensity is much lower than in FIG. 5B or 5C because reference light from the wafer 200 is mostly blocked by the polarization analyzer 150.

As shown in FIG. 6D, an intensity error normalized by applying the null conditions may be about 0.5238 or about 52.3%. Accordingly, the wafer 200 may be inspected by using the defect inspection system 100 that is under null conditions, so that it may be clearly determined whether there is a defect on the wafer 200.

For reference, when there is a defect on the wafer 200, the light intensity may be higher under the null conditions than when there is no defect on the wafer 200 because scattered light due to the defect may transmit through the polarization analyzer 150 and contribute toward increasing light intensity. Meanwhile, even if the null conditions are not applied, the light intensity of a defective wafer may be higher than that of a defectless wafer. However, since reference light having a very high intensity is also detected, a rate of increase in light intensity due to scattered light may be very slight. In other words, even though the light intensities in FIGS. 6B and 6C are two order of magnitude smaller than those of FIGS. 5B and 5C, the intensity error of FIG. 6D is two orders of magnitude larger than that of FIG. 5D.

FIG. 7 is a graph showing a normalized intensity error of FIG. 6D relative to a rotation angle A of the polarization analyzer (refer to 150 in FIG. 6A). Here, the abscissa denotes the rotation angle A, and the ordinate denotes the normalized intensity error.

Referring to FIG. 7, while the polarization analyzer 150 is rotating, normalized intensity errors between a defectless wafer (e.g., the sample 200s) and a defective wafer 200 may be obtained as described with reference to FIGS. 6B to 6D. Thereafter, a normalized intensity error relative to the rotation angle A of the polarization analyzer 150 may be indicated to obtain the graph of FIG. 7.

As can be seen from FIG. 7, the normalized intensity error may reach a peak at a rotation angle A of 24.91° (A=24.91°), which corresponds to null conditions. Also, a half-width of about 10° or more may be seen from the graph of FIG. 7. Accordingly, when the wafer 200 has a 100-nm defect, even if the rotation angle A of the polarization analyzer 150 is not precisely equalized to the null conditions but controlled to be near to the null conditions, the 100-nm defect may be sufficiently detected.

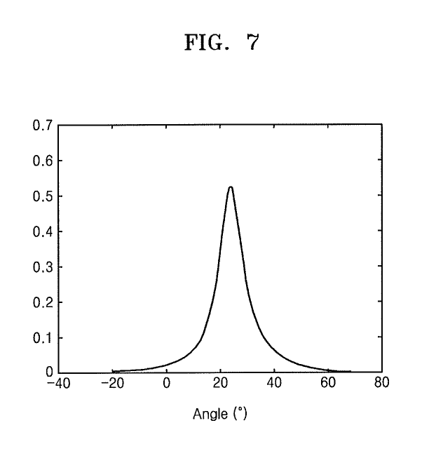

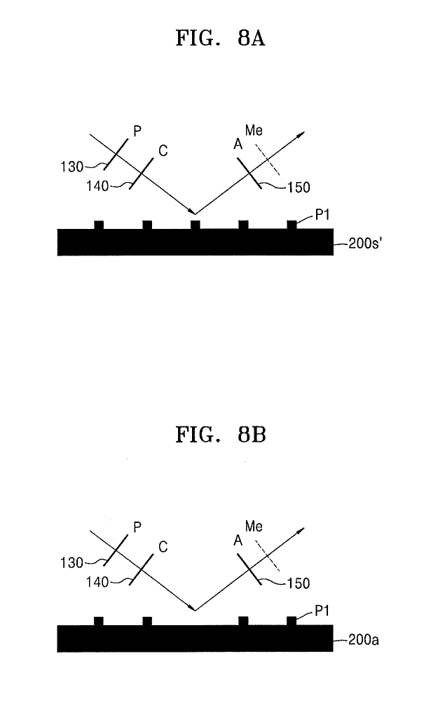

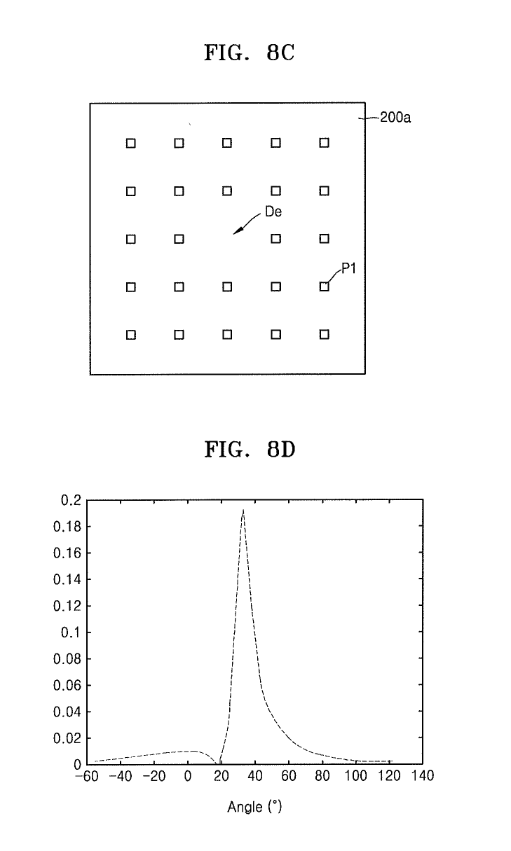

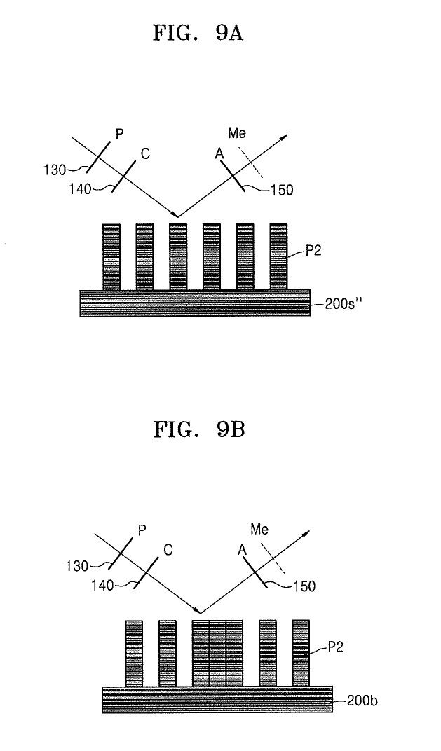

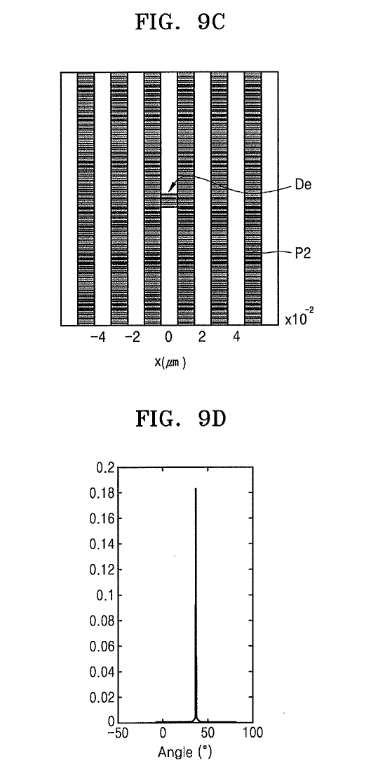

Thus far, a defect inspection on a patternless bare wafer has been described. However, the defect inspection system 100 according to the present embodiment is not limited to a patternless bare wafer but may be used to inspect a defect in a wafer having a periodic pattern. A defect inspection on the wafer having a periodic pattern will be described below with reference to FIGS. 8A to 9D.

FIG. 8A is a cross-sectional view of a defectless wafer 200s′ on which patterns are formed in a two-dimensional (2D) array. FIGS. 8B and 8C are a cross-sectional view and a plan view of a defective wafer 200a on which patterns are formed in a 2D array. FIG. 8D is a graph of a normalized intensity error relative to a rotation angle A of a polarization analyzer.

Referring to FIG. 8A, the defectless wafer 200s′ may have a thickness of about 300 nm, and silicon cubes, each of which is about 100 nm in width, length, and height, may be regularly arranged on a top surface of the defectless wafer 200s′. For example, the silicon cubes may be regularly arranged a distance of about 500 nm apart from one another in each of widthwise and lengthwise directions so that first patterns P1 may be formed in a 2D array. The wafer 200s′ on which the first patterns P1 are formed may correspond to a defectless sample.

Referring to FIGS. 8B and 8C, first patterns P1 may be formed in a 2D array on a top surface of the wafer 200a. However, the wafer 200a may include a defect De because one silicon cube is left out from a central portion of the wafer 200a.

To begin with, null conditions for the defectless wafer 200s′ may be obtained by using an FDTD simulation. Simulation conditions may be the same as described with reference to FIGS. 4A and 4B. Also, as in FIG. 4B, elliptical parameters Ψ and Δ may be obtained by using simulation values I(π/4,0,π/4), I(π/4,π/2,π/4), I(π/4,π/3,π/4), I(π/4,π/6,π/4). Thereafter, values P, C, and A corresponding to the null conditions may be obtained based on Equation: E(P,π/4,A)=0.

Although not shown, an average light intensity of the defectless wafer 200s′, which is detected by applying the null conditions, may be about 0.0057, while an average light intensity of the defective wafer 200a may be about 0.0068. Thus, a normalized intensity error may be 0.192 or about 19.2%. Accordingly, it may be sufficiently determined whether there is a defect in a wafer on which patterns are formed in a 2D array.

FIG. 8D is a graph corresponding to the graph of FIG. 7 and shows a normalized intensity error relative to a rotation angle A of the polarization analyzer 150 in the defective wafer 200a. As can be seen from the graph of FIG. 8D, the normalized intensity error may reach a peak at a rotation angle A of about 32.7° (A=32.7°), which corresponds to null conditions. Also, a half-width of about 10° or more may be seen from the graph of FIG. 8D. Here, a normalized intensity error corresponding to the half-width may be about 0.1 (i.e., about 10%). Accordingly, when there is a defect in a wafer on which patterns are formed in a 2D array, even if the rotation angle A of the polarization analyzer 150 is not precisely equalized to the null conditions but controlled to be near to the null conditions, the defect may be sufficiently detected.

FIG. 9A is a cross-sectional view of a defectless wafer 200s″ on which line and space (L/S) patterns are formed. FIGS. 9B and 9C are a cross-sectional view and a plan view of a defective wafer 200b on which L/S patterns are formed. FIG. 9D is a graph showing a normalized intensity error relative to a rotation angle A of a polarization analyzer.

Referring to FIG. 9A, the defectless wafer 200s″ may have a thickness of about 300 nm, and silicon lines, each of which is about 10 nm in width and about 40 nm in height, may be regularly arranged on a top surface of the defectless wafer 200s″. For example, the silicon lines may be regularly arranged a distance of about 10 nm apart from one another and form L/S-type second patterns P2. The wafer 200s″, on which the second patterns P2 are formed, may correspond to a defectless sample.

Referring to FIGS. 9B and 9C, L/S-type second patterns P2 may be formed on a top surface of the wafer 200b. However, the wafer 200b may include a defect De because silicon lines are connected to each other in a central portion of the wafer 200b. The connected portion between the silicon lines may be a defect corresponding to a short circuit.

To begin with, null conditions for the defectless wafer 200s″ may be obtained by using a finite difference time domain (FDTD) simulation. As in FIG. 4B, elliptical polarization parameters Ψ and Δ may be obtained by simulation values I(π/4,0,π/4), I(π/4,π/2,π/4), I(π/4,π/3,π/4), and I(π/4,π/6,π/4). Thereafter, values P, C, and A corresponding to the null conditions may be obtained based on Equation: E(P, π/4, A)=0. An average light intensity of the defectless wafer 200s″, which is detected by applying the obtained null conditions, may be about 1.616E(−8), while an average light intensity of the defective wafer 200b may be about 1.924E(−8). Thus, a normalized intensity error may be about 0.191 or about 19.1%. Accordingly, it may be sufficiently determined whether there is a defect in a wafer having L/S patterns.

FIG. 9D is a graph corresponding to the graph of FIG. 7 and shows a normalized intensity error relative to a rotation angle A of the polarization analyzer 150 in the defective wafer 200b. As can be seen from the graph of FIG. 9D, the normalized intensity error may reach a peak around a rotation angle of about 40°, which corresponds to the null conditions. Meanwhile, a half-width of almost about 0° may be seen from the graph of FIG. 9D. Accordingly, it can be seen that, to detect a defect in the wafer 200b of FIG. 9B, it may be necessary to precisely equalize the rotation angle A of the polarization analyzer 150 to the null conditions. The intensity of light scattered at a defect that is smaller than the wavelength of light may depend on Rayleigh scattering that is proportional to the square of the volume of the defect. A defect may be about 10 nm in width and length and about 40 nm in height may be at least 200 times smaller than the above-described 100-nm cube-type defect. Thus, the intensity of scattered light may be incomparably smaller than the intensity of incident light.

The above-described method of inspecting defects may be basically performed by using the low-magnification optics 160 having an equal magnification ratio of 1:1. If the low-magnification optics 160 having a magnification ratio of more than 1:1 (e.g., 1:10) is used, a normalized intensity error may increase. For example, when a 1:10 low-magnification optics 160 is applied to a wafer 100b on which L/S-type second patterns P2 are formed, since a normalized intensity error may be 6.31 or about 631%, it may be relatively easy to detect defects. Also, a half/width may also increase so that a permitted limit for equalizing a rotation angle A of the polarization analyzer 150 to null conditions may increase.

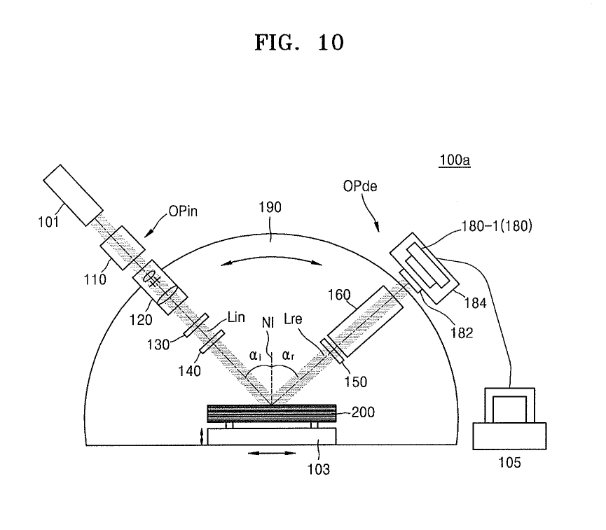

FIGS. 10 to 14 are schematic diagrams showing the configurations of defect inspection systems according to embodiments.

Referring to FIG. 10, a defect inspection system 100a according to the present embodiment may differ from the defect inspection system 100 of FIG. 1 in that a camera unit 180 includes only a first camera 180-1. Also, the defect inspection system 100a according to the present embodiment may not include the beam splitter (170 in FIG. 1). That is, since the camera unit 180 includes only the first camera 180-1, it may be unnecessary to split light from low-magnification optics 160, so that a beam splitter may be omitted.

In the defect inspection system 100a according to the present embodiment, the first camera 180-1 may be used as a high-sensitivity camera to detect defects under null conditions. Accordingly, the first camera 180-1 may be located in the airtight box 184, and a shutter 182 may be located at a front end of an entrance of the box 184. Also, the first camera 180-1 may be used to obtain null conditions of the defect inspection system 100a. Thus, the first camera 180-1 may include pixels that are not damaged by reference light. Meanwhile, the first camera 180-1 may be a sensitivity-variable camera capable of varying sensitivity. Thus, the first camera 180-1 may maintain a normal sensitivity or a low sensitivity to obtain null conditions, and maintain a high sensitivity to detect defects.

In some cases, in the defect inspection system 100a according to the present embodiment, the first camera 180-1 and the second camera (refer to 180-2 in FIG. 1) may be exchanged for each other. For example, the second camera may be located at a rear end of the low-magnification optics 160 to obtain null conditions. Also, the first camera 180-1 may be located at the rear end of the low-magnification optics 160 instead of the second camera to detect defects under null conditions.

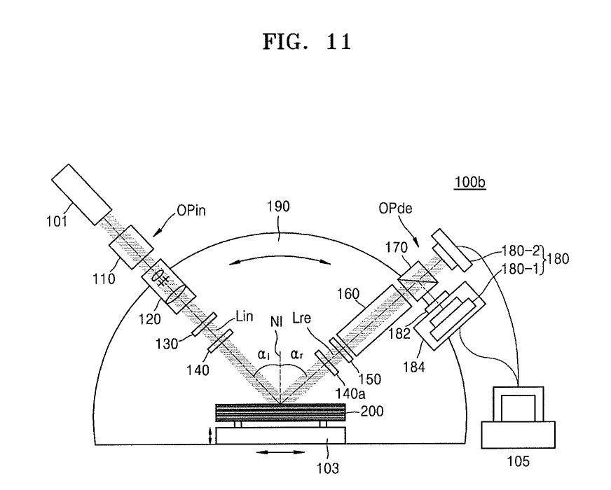

Referring to FIG. 11, the defect inspection system 100b according to the present embodiment may differ from the defect inspection system 100 of FIG. 1 in that a detection optics OPde further includes an additional compensator 140a. Specifically, in the defect inspection system 100b according to the present embodiment, the additional compensator 140a may be located at a front end of the polarization analyzer 150, e.g., between the target and the polarization analyzer 150. Functions and structures of the additional compensator 140a may be the same as those of the compensator 140 of the defect inspection system 100 of FIG. 1.

By adding the additional compensator 140a, null conditions may be precisely obtained, and the polarization analyzer 150 may effectively block reference light. However, since a rotation angle of the additional compensator 140a to an optical axis is added, light intensity may be measured at least four times to obtain the null conditions. Since the defect inspection system 100b according to the present embodiment includes incidence optics OPin having the compensator 140 and the detection optics OPde having the additional compensator 140a, the defect inspection system 100b may be referred to as a PCSCA ellipsometer system.

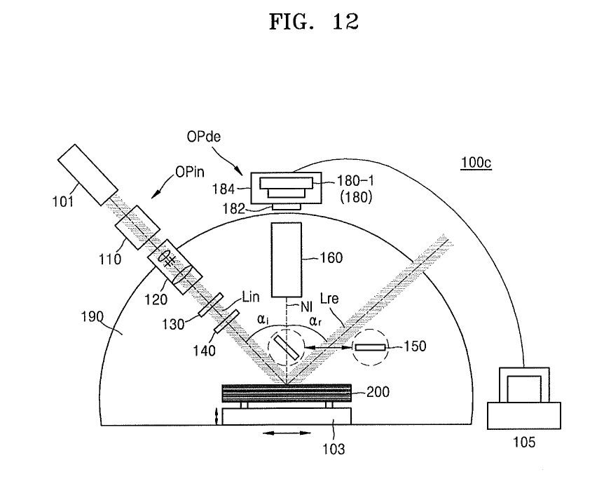

Referring to FIG. 12, a defect inspection system 100c according to the present embodiment may differ from the defect inspection system 100a of FIG. 10 in that the detection optics OPde is not located on a path of reflection light Lre. For example, in the defect inspection system 100c according to the present embodiment, the detection optics OPde may be located on a normal line Nl to a surface of an inspection target 200.

When the detection optics OPde is located on the normal line Nl to the surface of the inspection target 200, since most of reference light travels through the path of the reflection light Lre, effects of null conditions may be enhanced. In other words, under the null conditions, reference light transmitted through the polarization analyzer 150 located on the normal line Nl may almost disappear. Also, even if the null conditions are not applied, since the intensity of reference light toward the normal line Nl is slight, the first camera 180-1 may be used to obtain the null conditions, and pixels of the first camera 180-1 may not be damaged due to the reference light. Accordingly, in the defect inspection system 100c according to the present embodiment, the detection optics OPde may not include the beam splitter (refer to 170 in FIG. 1) and the second camera (refer to 180-2 in FIG. 1). In addition, it cannot be totally excluded that the detection optics OPde includes a beam splitter and a second camera.

The polarization analyzer 150 may be located at an angle or a right angle to the normal line Nl. For example, the polarization analyzer 150 may be located at such an angle as to effectively block reference light. When the polarization analyzer 150 is located on the path of reflection light Lre as in the defect inspection system 100 of FIG. 1, the polarization analyzer 150 may be located at a right angle to the path of reflection light Lre so as to effectively block reference light. When the polarization analyzer 150 is located in a portion other than the path of reflection light Lre, the polarization analyzer 150 may be located at an angle so that reference light may be effectively blocked by the polarization analyzer 150.

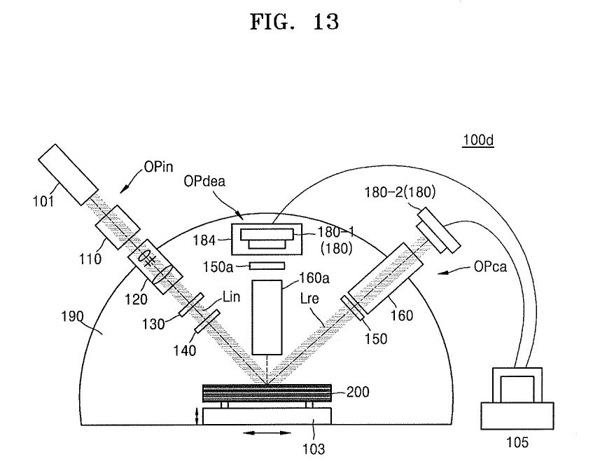

Referring to FIG. 13, the defect inspection system 100d according to the present embodiment may differ from the defect inspection systems 100 and 100a to 100c according to other embodiments in that a calibration optics OPca configured to find null conditions is separated from detection optics OPdea configured to closely inspect defects. Specifically, in the defect inspection system 100d according to the present embodiment, the calibration optics OPca may be located parallel to a path of reflection light, and the detection optics OPdea may be located on a normal line Nl to a surface of the inspection target 200. The defect inspection system 100d according to the present embodiment may correspond to a dual system obtained by combining the defect inspection system 100a of FIG. 10 and the defect inspection system 100c of FIG. 12.

As shown in FIG. 13, in the defect inspection system 100d according to the present embodiment, the detection optics OPdea may have a structure in which a polarization analyzer 150a is located after another low-magnification optics 160a, e.g., between the low-magnification optics 160a and the first camera 180-1. Thus, an objective of the low-magnification optics 160a may be located closer to the inspection target 200 so that detection of scattered light due to a defect may be maximized. In addition, another polarization analyzer 150a may be between the low-magnification optics 160a and the target 200. Also, a magnification of the detection optics OPdea may be easily adjusted by using the low-magnification optics 160a. The another low-magnification optics 160a may be substantially the same as the low-magnification optics 160. Furthermore, in the defect inspection system 100d according to the present embodiment, since the calibration optics OPca and the detection optics OPdea are located separately, a beam splitter may not be needed. Thus, optical loss due to the beam splitter may not occur.

In addition, the detection optics OPdea may be used not only to detect defects but also to find null conditions. For example, broad null conditions may be found by using the calibration optics OPca, and then precise null conditions may be found by using the detection optics OPdea. After the precise null conditions are found, the inspection target 200 may be inspected by using the detection optics OPdea so that defects may be precisely detected.

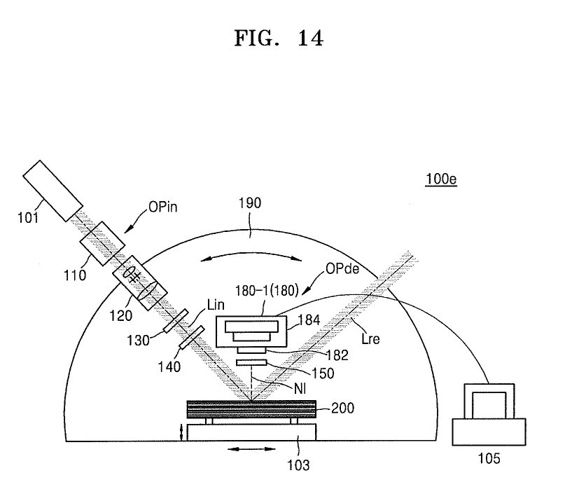

Referring to FIG. 14, a defect inspection system 100e according to the present embodiment may be similar to the defect inspection system 100c of FIG. 12 in that a detection optics OPde is not located on a path of reflection light Lre. However, in the defect inspection system 100e according to the present embodiment, the detection optics OPde may not include the low-magnification optics (refer to 160 in FIG. 12). For example, in the defect inspection system 100e according to the present embodiment, a camera unit 180 (e.g., the first camera 180-1) may be located on the normal line Nl to the surface of the inspection target 200 directly on the polarization analyzer 150. When the first camera 180-1 is located without low-magnification optics, the first camera 180-1 may detect light by using a digital holography method.

Thus far, the defect inspection systems 100 and 100a to 100e having various structures have been described. However, embodiments are not limited thereto. For example, defect inspection systems having any structures capable of detecting defects under null conditions by using high-sensitivity cameras after obtaining the null conditions may fall within the spirit and scope of the disclosure. Also, defect inspection systems having structures capable of detecting defects at a high speed under null conditions by using the low-magnification optics 160 may also fall within the spirit and scope of the disclosure.

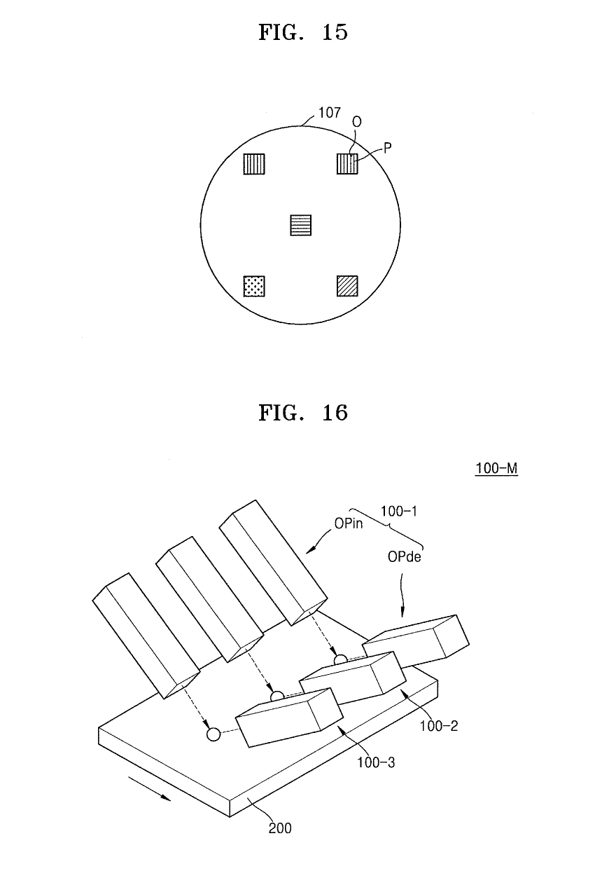

FIG. 15 is a plan view of a mask that may be located vertically over an inspection target 200 or in front of a camera in defect inspection systems according to embodiments.

Referring to FIG. 15, each of the above-described defect inspection systems 100 and 100a to 100e may further include a mask 107 located over the inspection target 200 or in front of a camera unit 180 (e.g., a first camera 180-1). Assuming that the inspection target 200 is a wafer, periodic patterns P may be formed on a portion of the wafer, and non-periodic patterns may be formed on the remaining portion of the wafer. In this case, the mask 107 exposing only the periodic patterns P may be located vertically over a wafer or in front of a camera, so that the defect inspection systems 100 and 100a to 100e may undergo a defect inspection on only the periodic patterns P. In FIG. 15, the periodic patterns P of the wafer may be exposed through an open region O of the mask 107. Meanwhile, when the mask 107 is located in front of the camera unit 180, the mask 107 may have a size corresponding to an entrance of the camera unit 180. Also, all or some of the periodic patterns P may be exposed through the open region O of the mask 107 according to a magnification of the low-magnification optics 160.

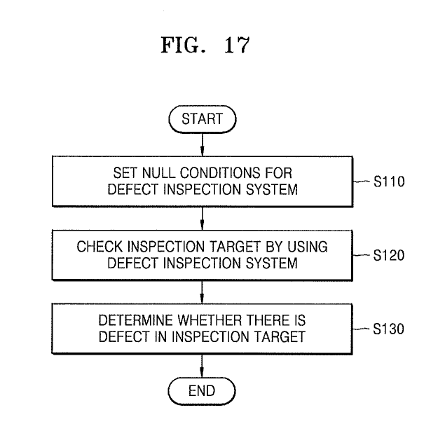

FIG. 16 is a schematic diagram showing the configuration of a multi-head defect inspection system 100-M according to an embodiment. Referring to FIG. 16, the multi-head defect inspection system 100-M according to the present embodiment may include three inspection heads 100-1, 100-2, and 100-3. Each of the three inspection heads 100-1, 100-2, and 100-3 may be embodied by any one of the defect inspection systems 100 and 100a to 100e shown in FIGS. 1 and 10 to 14. In FIG. 16, each of incidence optics OPin and detection optics OPde is simplified as a square pillar type, and the illustration of a rotation stage, a stage, and an analysis computer is omitted. Meanwhile, the stage and the analysis computer may be used in common.

The multi-head defect inspection system 100-M according to the present embodiment may include three inspection heads 100-1, 100-2, and 100-3, and may perform a defect inspection on an inspection target 200 at a high speed. Although the multi-head defect inspection system 100-M according to the present embodiment includes three inspection heads 100-1, 100-2, and 100-3, the number of inspection heads is not limited thereto. For example, the multi-head defect inspection system 100-M according to the present embodiment may include two inspection heads or four or more inspection heads.

FIG. 17 is a flowchart of a method of inspecting defects according to an embodiment. The flowchart of FIG. 17 will be described with reference to the defect inspection system 100 of FIG. 1 for brevity.

Referring to FIG. 17, to begin with, null conditions of the defect inspection system 100 may be set by using a defectless sample (S110). A specific method of setting the null conditions may be the same as described with reference to FIG. 3.

After the null conditions are set, an inspection target 200 may be checked by using the defect inspection system 100 that is under the null conditions (S120). When the inspection target 200 is checked under the null conditions, reference light corresponding to reflection light in a defectless state may be completely or mostly blocked by the polarization analyzer 150.

Thereafter, it may be determined whether there is a defect in the inspection target 200 by analyzing the checking result (S130). For example, the checking result of the inspection target 200 may be compared with that of a defectless sample. If the checking result of the inspection target 200 matches that of the defectless sample, it may be determined that there is no defect in the inspection target 200. If the checking result of the inspection target 200 is not equal to the checking result of the defectless sample, it may be determined that there is a defect in the inspection target 200.

Meanwhile, since the inspection target 200 is not completely identical to the sample, even if there is no defect in the inspection target 200, there may be a difference between the checking result of the inspection target 200 and that of the defectless sample. Accordingly, it may be determined whether there is a defect based on the concept of the normalized intensity error described above with reference to FIG. 5D or 6D. For example, if the normalized intensity error is about 10% or higher, it may be determined that there is a defect in the inspection target 200. If the normalized intensity error is lower than about 10%, it may be determined that there is no defect in the inspection target 200. A standard for the normalized intensity error, which is used in determining whether there is a defect, is not limited to 10%. For example, the standard for the normalized intensity error, which is used in determining whether there is a defect, may be variously set (e.g., about 5% or 20%) according to the inspection target 200 and a shape and characteristics of the defect.

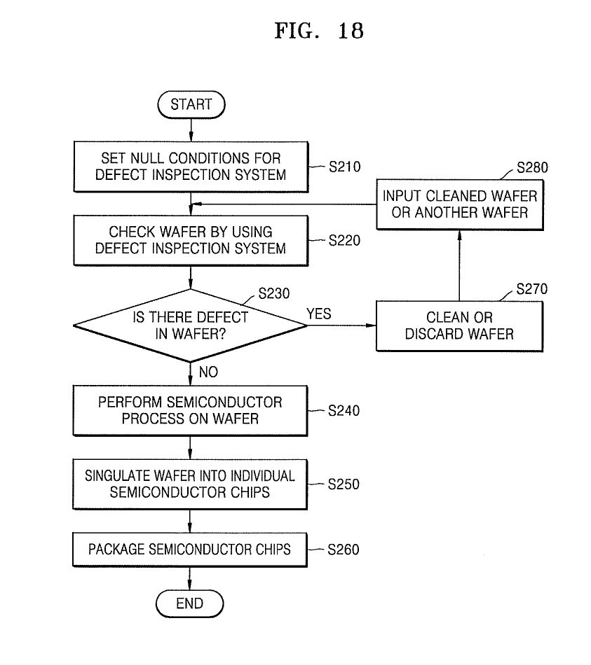

FIG. 18 is a flowchart of a method of fabricating a semiconductor device by using a method of inspecting defects, according to an embodiment. Similarly, the flowchart of FIG. 18 will be described with reference to the defect inspection system 100 of FIG. 1.

Referring to FIG. 18, an operation (S210) of setting null conditions through an operation (S230) of determining whether there is a defect may be the same as described above with reference to FIG. 17. However, in an operation (S220) of checking the wafer, a specific wafer may be checked instead of the inspection target 200. Also, the method may return to a different next operation based on the determination result of the operation (S230).

If there is no defect in the wafer (No), a semiconductor process may be performed on the wafer (S240). The semiconductor process may include various processes. For example, the semiconductor process may include a deposition process, an etching process, an ion process, and a cleaning process. By performing the semiconductor process on the wafer, integrated circuits (ICs) and interconnections required for the semiconductor device may be formed. The semiconductor process may include a process of testing a wafer-level semiconductor device. Meanwhile, during the semiconductor process on the wafer, the process (S210) of setting the null conditions through the process (S230) of determining whether there is a defect may be performed on the periodic pattern formed on the wafer.

If semiconductor chips are completely formed in the wafer by performing the semiconductor process on the wafer, the wafer may be singulated into individual semiconductor chips (S250). The singulation of the wafer into the individual semiconductor chips may be performed by, e.g., a sawing process using a blade or a laser.

Thereafter, the semiconductor chips may be packaged (S260). The packaging process may include mounting the semiconductor chips on a printed circuit board (PCB) and encapsulating the resultant structure by using an encapsulant. Meanwhile, the packaging process may include stacking a plurality of semiconductor layers on a PCB to form a stack package or stacking a stack package on a stack package to form a Package-on-Package (PoP) structure. Semiconductor devices or semiconductor packages may be completely formed by packaging the semiconductor chips. Meanwhile, the packaging process may be followed by a process of testing the semiconductor packages.

If there is a defect in the wafer (Yes), the wafer may be cleaned or discarded (S270). Thereafter, the cleaned wafer or another wafer may be loaded into the defect inspection system 100 (S280), and the method may return to the process of checking the wafer (S220).

Embodiments provide a defect inspection system and a method of inspecting defects, by which defects of an inspection target may be precisely detected at a high speed. Also, embodiments provide a method of fabricating a semiconductor device by using the method of inspecting defects, which may improve reliability of a semiconductor device and yield of a semiconductor process.

Some elements of embodiments are described, and illustrated in the drawings, in terms of functional blocks, units and/or modules, e.g., as a computer. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the embodiments may be physically separated into two or more interacting and discrete blocks, units and/or modules without departing from the scope of the disclosure. Further, the blocks, units and/or modules of the embodiments may be physically combined into more complex blocks, units and/or modules without departing from the scope of the disclosure.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

1. A defect inspection system, comprising:
a light source;
a linear polarizer to linearly polarize light from the light source;
a compensator to circularly or elliptically polarize light from the linear polarizer;
a stage on which an inspection target is to be located;
a polarization analyzer to selectively transmit light reflected by the inspection target; and
a first camera to collect light from the polarization analyzer,
wherein light transmitted through the compensator is obliquely incident to the inspection target, and reference light, which corresponds to light reflected in a defectless state, from among the light reflected by the inspection target, is blocked by the polarization analyzer.

2. The system as claimed in claim 1, wherein, to block the reference light, rotation angles of the linear polarizer, the compensator, and the polarization analyzer about an optical axis are set to block light reflected by a defectless sample.

3. The system as claimed in claim 2, further comprising:
a beam splitter to split light from the polarization analyzer into two light beams, wherein the first camera is positioned to collect a first light beam of the two split light beams; and
a second camera is positioned to collect a second light beam of the two light beams, and
at least one of the first and second cameras is a high-sensitivity camera having an International Organization for Standardization (ISO) sensitivity of about 3000 or higher.

4. The system as claimed in claim 3, wherein:
the first and second cameras are used to set the rotation angles,
the high-sensitivity camera is a line scan camera and used to detect defects in the inspection target.

5. The system as claimed in claim 3, wherein a shutter to block light is located in front of the high-sensitivity camera.

6. The system as claimed in claim 1, further comprising a low-magnification optics having a magnification ratio from 1:1 to 1:100, wherein the low-magnification optics is to image a surface of the inspection target on the first camera.

7. The system as claimed in claim 1, wherein the light source is a broadband light source, the system further comprising:
a monochromator to convert broadband light from the light source into single-wavelength light;
a beam collimator to collimate light from the monochromator and output collimated light;
low-magnification optics to image light at a low magnification ratio; and
a beam splitter to split light from the low-magnification optics into two light beams,
wherein the first camera is to collect a first light beam of the two light beams, and
a second camera is to collect a second light beam of the two light beams.

8. The system as claimed in claim 1, wherein the polarization analyzer and the first camera are located in a path of the reflected light or located on a normal line to a surface of the inspection target.

9. The system as claimed in claim 8, wherein, when the polarization analyzer and the first camera are located on the normal line, the polarization analyzer is located at an angle to the normal line.

10. The system as claimed in claim 1, wherein at least one of the linear polarizer, the compensator, and the polarization analyzer is an electronic device to be controlled in response to an electric signal.

11. The system as claimed in claim 1, further comprising:
a low-magnification optics to image light onto the first detector, and
an additional compensator before the polarization analyzer.

12. A multi-head defect inspection system, comprising:
at least two inspection heads; and
a stage on which an inspection target is located,
wherein each of the inspection heads includes:
a light source;
a linear polarizer to linearly polarize light from the light source;
a compensator to circularly or elliptically polarize light from the linear polarizer;
a polarization analyzer to selectively transmit light reflected by the inspection target; and
at least one camera to collect light from the polarization analyzer,
wherein light transmitted through the compensator is obliquely incident to the inspection target, reference light, which corresponds to light reflected in a defectless state, from among the light reflected by the inspection target, is blocked by the polarization analyzer.

13.-26. (canceled)

27. A defect inspection system, comprising:
a light source;
a linear polarizer to linearly polarize light from the light source;
a stage on which an inspection target is to be located and positioned to receive light at an oblique angle;
a polarization analyzer to selectively transmit light reflected by the inspection target; and
a camera to collect light from the polarization analyzer, wherein a minority of light incident on the polarization analyzer from a defectless target is incident on the camera.

28. The defect inspection system as claimed in claim 27, further comprising an analysis computer to receive signals output from the camera when an inspection target is on the stage and to compare received signals to those from the defectless target.

29. The defect inspection system as claimed in claim 27, further comprising a compensator between the linear polarizer and the stage, the compensator to circularly or elliptically polarize light from the linear polarizer.

30. The defect inspection system as claimed in claim 27, further comprising a low-magnification optics having a magnification ratio from 1:1 to 1:100, wherein the low-magnification optics is to image a surface of the inspection target on the camera.

31. The defect inspection system as claimed in claim 27, wherein the light incident on the stage is monochromatic.
